(19) United States
(12) Patent Application Publication
(10) Pub. No.: US 2026/0221924 A1
(43) Pub. Date: Jul. 30, 2026

(54) MOTOR CONTROL DEVICE

(71) Applicant: LG INNOTEK CO., LTD., Seoul (KR)

(72) Inventor: Seung Hyeong LEE, Seoul (KR)

(21) Appl. No.: 19/141,736

(22) PCT Filed: Jan. 9, 2024
(86) PCT No.: PCT/KR2024/000418

§ 371 Date: Jun. 20, 2025

(30) Foreign Application Priority Data
Feb. 7, 2023 (KR) 10-2023-0016154

(51) Int. Cl. H02P 29/024; B60W 10/08; B60W 20/00

(52) U.S. Cl. CPC H02P 29/027; B60W 10/08; B60W 20/00; B60W 2710/08

(57) ABSTRACT

Disclosed in an embodiment of the present invention is a motor control device comprising: a first power source connection unit for receiving first power source; a second power source connection unit for receiving second power source that is smaller than the first power source; a driving unit connected to a motor so as to supply the first power source, thereby driving the motor; and a control unit, which transmits, to the driving unit, a pulse modulation signal for driving the motor, the first power source connection unit, the driving unit and the control unit being high-voltage units for receiving the first power source, and the second power source connection unit being a low-voltage unit for receiving the second power source; and insulating units and a conversion unit, which connect the high-voltage units and the low-voltage unit, the low-voltage unit resetting the control unit according to whether the control unit is driven.

### DESCRIPTION

### Technical Field

The present invention relates to a motor control device.

### Background Art

In general, hybrid electric vehicles (HEVs) or plug-in hybrid electric vehicles (PHEVs) are vehicles in which power sources with two or more different types are effectively combined to drive the vehicles, and in most cases, diving forces are obtained from engines using fuel and electric motors using battery power.

Recently, in response to the demand of the times to improve fuel efficiency and develop more eco-friendly products, research on HEVs has been conducted more actively.

An HEV is a vehicle basically including an engine, a motor, a vehicle battery, and a high-voltage battery, and recently, a PHEV, in which a capacity of a high-voltage battery is formed to be greater than that of the conventional HEV and the high-voltage battery is charged from an external power source and which travels in only an electric vehicle (EV) mode during short distance traveling and travels in an HEV mode when the high-voltage battery is discharged, has been under development.

In addition, a PHEV is a vehicle in which both an internal combustion engine driven using fuel and a battery engine are mounted like the conventional HEV, which is driven using one or both of two engines, and in which a high-voltage battery with a large capacity is mounted to be charged with electricity, and since the PHEV may be charged with electricity in a home or charging station, like a mobile phone being charged or a tank being filled with gas, there is an advantage of continuous usability.

Such an HEV or PHEV is a vehicle basically including an engine, a motor, a battery, and a high-voltage battery. In response to the demand for HEVs or PHEVs, there is a need to develop a technology for driving an oil pump using power of the high-voltage battery.

### DETAILED DESCRIPTION OF INVENTION

### Technical Problem

A technical object to be achieved from an embodiment of the present invention is directed to providing a motor control device in which an element is disposed in each of a high-voltage unit and a low-voltage unit to improve reliability and make the motor control device compact.

In addition, an embodiment of the present invention is also directed to providing a motor control device in which a low-voltage unit monitors a control unit of a high-voltage unit to improve operation stability of the control unit.

In addition, an embodiment of the present invention is directed to providing a motor control device which doubly detects an abnormality of a motor or circuit to improve reliability.

Problems to be solved by embodiments are not limited thereto and include objectives or effects that may be identified through solutions to the problems or embodiments which will be described below.

### Technical Solution

A motor control device according on an embodiment of the present invention includes a first power connection unit which receives first power, a second power connection unit which receives second power lower than the first power, a driving unit which is connected to a motor and drives the motor by supplying the first power to the motor, a control unit which transmits a pulse width modulation signal for driving the motor to the driving unit, and an insulating unit and a conversion unit which are disposed between and connected to a high-voltage unit and a low-voltage unit, wherein the high-voltage unit includes the first power connection unit, the driving unit, and the control unit and receives the first power, the low-voltage unit includes the second power connection unit and receives the second power, and the low-voltage unit resets the control unit according to whether the control unit operates.

The conversion unit may insulate the high-voltage unit from the low-voltage unit and provide third power stepped up from the second power to the high-voltage unit.

The third power may be provided to the driving unit.

The high-voltage unit may include a first regulator which is connected to the conversion unit and steps the third voltage down and a sensor power unit.

The first regulator may provide the stepped-down voltage to the control unit.

The low-voltage unit may include a second regulator which is connected to the control unit and receives an operation signal of the control unit and a third regulator which provides power to an external sensor.

The second regulator may step the second power down and transmit a reset signal to the control unit in response to the operation signal of the control unit.

The low-voltage unit may include a conversion circuit connected to each of the second power and the ignition key, and the conversion circuit may include a triangular wave generation circuit and a comparator connected to the triangular wave generation circuit and any one of the second power and the ignition key.

The comparator may be connected to the control unit.

The conversion circuit may output a signal with a duty ratio corresponding to a change in the second power or the ignition key.

The motor control device may include an overcurrent detection circuit connected to a detection element disposed between the motor and the control unit and a determination unit connected to the overcurrent detection circuit and the control unit.

The determination unit may output an overcurrent detection signal upon detecting an overcurrent in any one phase from the overcurrent detection circuit or the control unit.

The detection element may be connected to the control unit.

### Advantageous Effects

An embodiment of the present invention implements a motor control device in which an element is disposed in each of a high-voltage unit and a low-voltage unit to improve reliability and make the motor control device compact.

In addition, an embodiment of the present invention can implement a motor control device in which a low-voltage unit monitors a control unit of a high-voltage unit to improve operation stability of the control unit.

In addition, an embodiment of the present invention can implement a motor control device which doubly detects an abnormality of a motor or circuit to improve reliability.

Various useful advantages and effects of the present invention are not limited to the above-described content and may be more easily understood from description of specific embodiments of the present invention.

### DESCRIPTION OF DRAWINGS

FIG. 1 is a block diagram illustrating a motor control device and a battery, a high-voltage battery, a position sensor, and a motor which are connected to the motor control device according to an embodiment.

FIG. 2 is a block diagram for describing an operation check function of a control unit of a high-voltage unit in the motor control device according to the embodiment.

FIG. 3 is a block diagram for describing an operation of voltage monitoring in the motor control device according to the embodiment.

FIG. 4 is a specific circuit diagram of a conversion circuit in FIG. 3.

FIG. 5 is a block diagram for describing operation of an overcurrent detection circuit in the motor control device according to the embodiment.

### MODES OF THE INVENTION

Since the present invention allows various changes and has many embodiments, specific embodiments will be illustrated in the accompanying drawings and described. However, this is not intended to limit the present invention to the specific embodiments, and it is to be appreciated that all changes, equivalents, and substitutes that fall within the spirit and technical scope of the present invention are encompassed in the present invention.

Although the terms “first,” “second,” and the like may be used to describe various elements, these elements should not be limited by these terms. These terms are only used to distinguish one element from another element. For example, a second element could be termed a first element, and a first element could similarly be termed a second element without departing from the scope of the present invention. The term “and/or” includes any one or any combination of a plurality of associated listed items.

When a first element is referred to as being “connected” or “coupled” to a second element, it will be understood that the first element may be directly connected or coupled to the second element, or a third element may be present therebetween. In contrast, when an element is referred to as being “directly connected” or “directly coupled” to another element, it will be understood that there are no intervening elements.

The terminology used herein is for the purpose of describing particular embodiments only and is not intended to limit the present invention. The singular forms are intended to include the plural forms, unless the context clearly indicates otherwise. In the present specification, it should be further understood that the terms “comprise,” “comprising,” “include,” and/or “including,” specify the presence of stated features, numbers, steps, operations, elements, components and/or combinations thereof but do not preclude the presence or addition of one or more other features, numbers, steps, operations, elements, components, and/or combinations thereof.

Unless otherwise defined, all terms including technical and scientific terms used herein have meanings which are the same as meanings generally understood by those skilled in the art. Terms, such as those defined in commonly used dictionaries, should be interpreted as having meanings that are consistent with their meanings in the context of the relevant art and will not be interpreted in an idealized or overly formal sense unless expressly so defined here.

Hereinafter, when embodiments are described in detail with reference to the accompanying drawings, components that are the same or correspond to each other will be denoted by the same or corresponding reference numerals in all drawings, and redundant descriptions will be omitted.

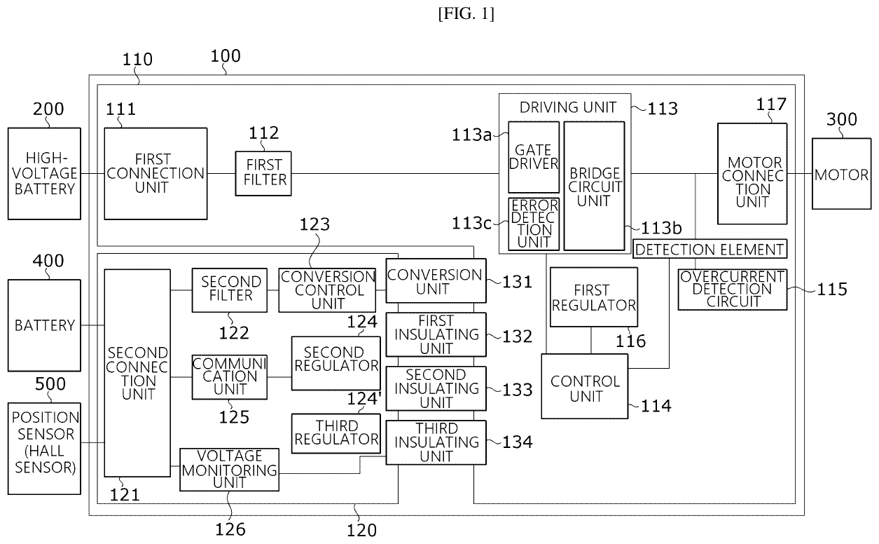

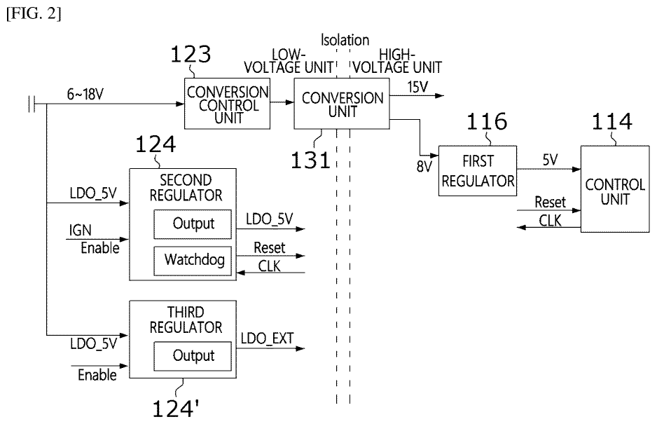

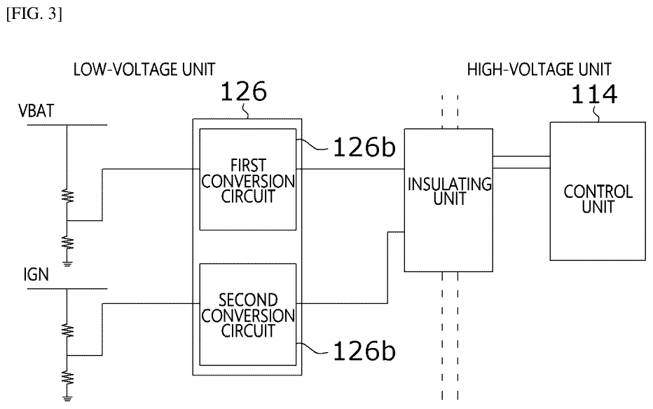

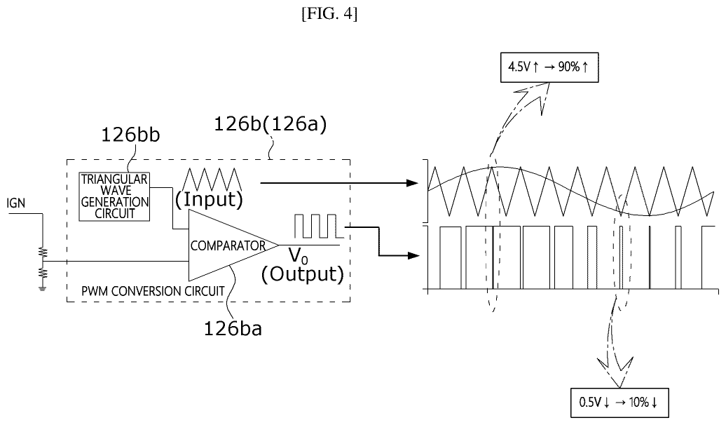

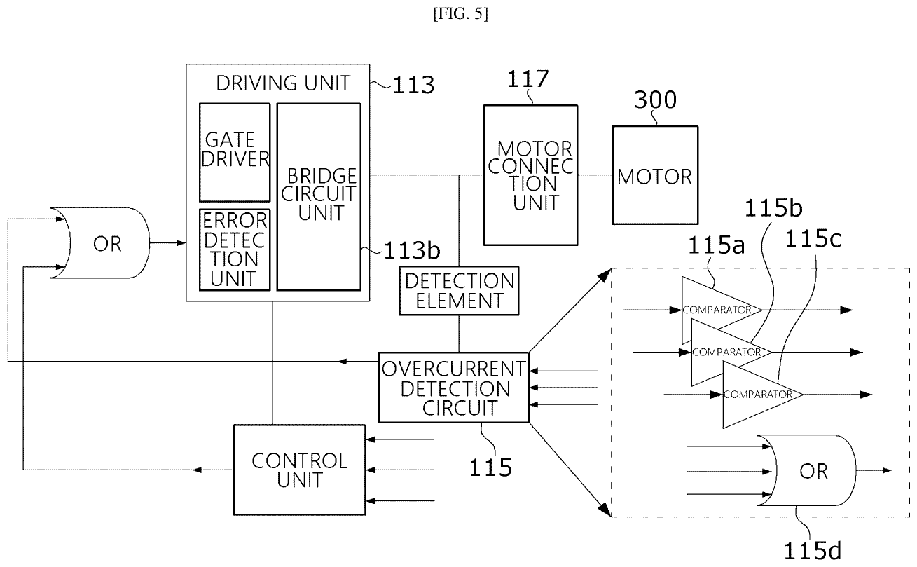

FIG. 1 is a block diagram illustrating a motor control device and a battery, a high-voltage battery, a position sensor, and a motor which are connected to the motor control device according to an embodiment, FIG. 2 is a block diagram for describing an operation check function of a control unit of a high-voltage unit in the motor control device according to the embodiment. FIG. 3 is a block diagram for describing an operation of voltage monitoring in the motor control device according to the embodiment, and FIG. 4 is a specific circuit diagram of a conversion circuit in FIG. 3. FIG. 5 is a block diagram for describing operation of an overcurrent detection circuit in the motor control device according to the embodiment.

First, the motor control device and the battery, the high-voltage battery, the position sensor, and the motor which are connected to the motor control device according to the embodiment of the present invention may be disposed in a vehicle.

In addition, the motor control device according to the embodiment may control a motor for an oil pump applied to the vehicle. In addition, the motor control device according to the embodiment may be applied to various types of vehicles (for example, a hybrid electric vehicle and a plug-in hybrid electric vehicle). In addition, although the present embodiment will be described without distinguishing an installation location of the oil pump, the present invention may be applied to both a built-in oil pump installed in an oil fan and an external oil pump installed outside an oil fan.

Referring to FIGS. 1 and 2, a motor 300 may be the motor for driving the oil pump. For example, the motor 300 may include an LDC motor, a brushless AC (BLAC) motor, or the like. For example, the motor 300 may include a 3-phase LDC motor, a 3-phase BLAC motor, or the like.

In addition, a battery 400 provided in the vehicle (HEV or the like) in the present embodiment may provide power (for example, always-on power VB) to a motor control device 100, and when an ignition key is turned on, ignition key input power IG may be activated. In other words, the battery 400 provided in the vehicle (hybrid electric vehicle or plug-in hybrid electric vehicle) applies always-on power to the motor control device 100 or a control unit 114 for driving the motor 300 and applies the ignition key input power to a driving unit 113 which is a component for driving the motor 300 when an ignition key IGN is turned on.

In other words, the motor control device 100 may receive second power which is always-on power through a second connection unit 121. The second power or power VB may be provided to a conversion unit 131 through a second filter 122 and a conversion control unit 123. The conversion unit 131 may supply a predetermined voltage to a high-voltage unit 110 through the conversion control unit 123. For example, the conversion unit 131 may boost the second power (second voltage) to third power (third voltage). For example, the conversion unit 131 may output the third voltage of 15 V. In addition, the conversion unit 131 may be connected to a converter, etc. An overcurrent detection circuit 115 may convert (for example, step down) the third voltage into a predetermined voltage level (for example, 5 V). Accordingly, the converted voltage may be provided to the control unit 114, a first insulating unit 132, a second insulating unit 133, a third insulating unit 134, etc.

In addition, the motor control device 100 for a vehicle according to the embodiment of the present invention includes the high-voltage unit 110 which receives a voltage of a high-voltage battery 200, a low-voltage unit 120 which receives a voltage, for example, a low voltage of 12 V, of the battery 400, and the conversion unit 131 which converts a low-voltage signal transmitted from the low-voltage unit 120 to a high-voltage signal and transmits the high-voltage signal to the high-voltage unit 110 in a state in which the high-voltage unit 110 and the low-voltage unit 120 are insulated from each other. In addition, the motor control device 100 for a vehicle according to the embodiment may further include the first insulating unit 132, the second insulating unit 133, and the third insulating unit 134 which are disposed between the high-voltage unit 110 and the low-voltage unit 120 and insulated from each other. In addition, the high-voltage unit 110 and the low-voltage unit 120 may be electrically insulated or separated from each other. In particular, a signal may be transmitted, received, or stepped up only by the first insulating unit, the second insulating unit, the third insulating unit, and the conversion unit. This will be described below.

In addition, the high-voltage battery 200 disposed in the vehicle may supply a high voltage HV of, for example, 100 V or more, or a first voltage to a gate driver 113a and a bridge circuit unit 113b of the driving unit 113 which drives the motor 300. That is, it should be noted that the high voltage of 100 V or more may drive the motor 300 in the present invention. Accordingly, in the present invention, even in an over discharge state of the high-voltage battery 200, the motor can be driven normally.

The motor control device 100 may include the high-voltage unit 110, the low-voltage unit 120, the first insulating unit 132, the second insulating unit 133, the third insulating unit 134, and the conversion unit 131.

In addition, the high-voltage unit 110 may include a first connection unit 111, a first filter 112, the driving unit 113, the control unit 114, the overcurrent detection circuit 115, a first regulator 116, and a motor connection unit 117.

The low-voltage unit 120 may include the second connection unit 121, the second filter 122, the conversion control unit 123, a second regulator 124, a third regulator 124′, a communication unit 125, and a voltage monitoring unit 126.

In this case, each of the first connection unit 111, the second connection unit 121, and the motor connection unit 117 may include a connector for connection with an external device (the high-voltage battery, the battery, the motor, and the position sensor) of the motor control device 100. In addition, the first connection unit and the second connection unit may be called a “first power connection unit,” and a “second power connection unit,” respectively.

Specifically, in the high-voltage unit 110, the first connection unit 111 may receive the first power, which is a high voltage, from the high-voltage battery 200.

The first filter 112 may be connected to the high-voltage unit 110. The first filter 112 may include an electromagnetic compatibility (EMC) filter. The first filter 112 may reduce EMC noise contained in the high voltage.

The driving unit 113 may be connected to the motor 300 and drive the motor 300 by supplying the first voltage to the motor 300. The driving unit 113 may include the gate driver 113a, the bridge circuit unit 113b, and an error detection unit 113c.

The gate driver 113a may include a circuit which performs switching using a signal (pulse width modulation (PWM) signal) received from the control unit 114. That is, the gate driver 113a may include a switching circuit by which a PWM signal is or is not output. In the embodiment, the gate driver 113a may include a high-voltage integrated circuit gate driver driven by the high voltage or first voltage of the high-voltage battery 200.

The bridge circuit unit 113b may be connected to the gate driver 113a. In addition, the bridge circuit unit 113b may be a driving means for the gate driver 113a to drive the motor 300. The bridge circuit unit 113b may include a 3-phase full bridge circuit. In addition, the bridge circuit unit 113b may be formed with an insulated gate bipolar transistor (IGBT) element or a field effect transistor (FET) element.

For example, N channel IGBT elements are used at both a high side and a low side of the driving unit 113.

In the HEV or the like, the motor 300 is driven using the first power of the high-voltage battery 200, the bridge circuit unit 113b includes the IGBT element, and thus safety of high-voltage switching can be improved.

In addition, the position sensor or a position sensor 500 may detect a change in a magnetic field according to a position of a rotor provided in the motor 300 and transmit a detection signal to the control unit 114 through the second connection unit and the third insulating unit.

The error detection unit 113c may detect an operation failure, an error, etc., of the driving unit 113. Through this, the control unit 114 or the driving unit 113 may stop a switching operation of the driving unit 113 when a voltage of the bridge circuit unit 113b is a voltage higher than or equal to a preset voltage. The error detection unit 113c may be connected to the control unit 114 and the overcurrent detection circuit 115. This will be described below.

In addition, the driving unit 113 may receive a high voltage with reduced noise from the first filter 112.

The control unit 114 may transmit a PWM signal for driving the motor 300 to the driving unit 113.

The control unit 114 may drive the motor 300 according to a command from an external device or main control unit (not shown) in the vehicle through the communication unit 125. That is, when the control unit 114 receives a target number of revolutions per minute (RPM) of the oil pump, the control unit 114 may output a PWM signal for driving the motor 300 and transmit the PWM signal to the driving unit 113. Accordingly, the motor 300 may be driven finally.

In other words, the control unit 114 may receive an RPM and a target RPM of a vehicle engine from the main control unit such as a micro controller unit (MCU) or transmission control unit (TCU). In addition, the control unit 114 may output a PWM signal corresponding to the received target RPM, and the control unit 114 may be connected to a detection element (shunt) R connected to an output terminal of the driving unit 113 and may receive a signal (for example, a current value) corresponding to an actual RPM. In particular, the control unit 114 may be directly connected to the detection element connected to the output terminal of the driving unit 113 without an insulating element. That is, an insulation device is not present between the detection element and the control unit 114.

In addition, the control unit 114 may transmit the signal corresponding to the received actual RPM to the main control unit through the communication unit 125 and the first and second insulating units.

In addition, a predetermined time interval method or time-variant method may be applied to an internal control interval of the control unit 114. In the case of the time-variant method, the internal control interval is inversely proportional to an RPM of the motor 300. In addition, the control unit 114 may perform feedback control such that the motor 300 reaches a target RPM using a PWM duty (%) calculated to be increased or decreased through proportional integral derivation (PID) control, and thus more exact control can be performed.

In addition, the control unit 114 may set a rotary speed of the motor 300, diagnose whether an abnormality of the position sensor 500 occurs, and determine whether the motor 300 is driven normally on the basis of a detection signal transmitted from the position sensor 500 which detects a position of the motor 300.

In addition, the control unit 114 may control the motor 300 to be driven according to a command from the main control unit transmitted through the communication unit 125.

Meanwhile, a TCU connection line (not shown) using a hard wire may be provided between the control unit 114 and a TCU of the main control unit such that communication is possible even when controller area network (CAN) communication fails.

The overcurrent detection circuit 115 may be connected to the detection element to protect the driving unit 113. This will be described below.

The conversion control unit 123 may be connected to the conversion unit 131. When the second power (second voltage) is stepped up to the third power (third voltage) in the conversion unit 131, the first regulator 116 may convert the third voltage into a predetermined voltage level (about 5 V). In addition, the predetermined voltage level (about 5 V) may be provided to the control unit 114.

In other words, the first regulator 116 may be connected to the conversion unit 131. Accordingly, the first regulator 116 may receive the third voltage output from the conversion unit 131. The first regulator 116 may convert a voltage level of the third power into a specific voltage level (for example, 5 V) and output the converted specific voltage level (for example, 5 V) to the control unit 114, etc.

In addition, the motor connection unit 117 may receive power (for example, 3 phases (a U-phase, a V-phase, and a W-phase) of power) output from the driving unit 113. In addition, the motor connection unit 117 may supply the received power to the connected motor 300. Accordingly, the motor can be driven for the oil pump.

In addition, in the low-voltage unit 120, the second connection unit 121 may receive the second power from the battery 400. In this case, the second power may be lower than the first power as described above.

The second filter 122 may be connected to the second connection unit 121. The second filter 122 may include an EMC filter. The second filter 122 may reduce EMC noise contained in the second power.

The conversion control unit 123 may be connected to the second connection unit 121 or the second filter 122. The conversion control unit 123 may be a PWM controller. The conversion control unit 123 may be connected to the conversion unit 131 and transmit a PWM signal to the conversion unit 131. The conversion unit 131 may perform boosting in response to the PWM signal.

The second regulator 124 may be connected to the second connection unit 121 or the second filter 122.

The second regulator 124 may receive the second power and convert the second power into a specific voltage level (for example, 5 V). The converted voltage may be supplied to the communication unit 125 connected to the second regulator 124.

In addition, the low-voltage unit 120 may include the third regulator 124′. The third regulator 124′ may be connected to the second regulator 124, may convert the second voltage into a specific voltage level (for example, 5 V), and may supply the converted specific voltage level (for example, 5 V) to an external sensor or element.

The communication unit 125 may be formed with an element for CAN communication. In addition, the communication unit 125 may communicate with the external main control unit through the second connection unit 121. In addition, the communication unit 125 may be connected to any one of the first insulating unit 132, the second insulating unit 133, and the third insulating unit 134 and communicate with the control unit 114, etc. In other words, the communication unit 125 may perform communication between the control unit 114 and the external control unit through the third insulating unit 134.

The voltage monitoring unit 126 may be connected to the control unit 114 through the second insulating unit and may monitor or detect operation of the control unit 114. This will be described in detail below.

The first insulating unit 132, the second insulating unit 133, and the third insulating unit 134 may be located between the high-voltage unit 110 and the low-voltage unit 120. The first insulating unit 132, the second insulating unit 133, and the third insulating unit 134 may transmit a communication signal of the low-voltage unit to an element (for example, the control unit) of the high-voltage unit 110. In addition, the first insulating unit 132, the second insulating unit 133, and the third insulating unit 134 may receive a communication signal of the low-voltage unit from the control unit 114 of the high-voltage unit 110.

The first insulating unit 132, the second insulating unit 133, and the third insulating unit 134 may insulate the high-voltage unit 110 from the low-voltage unit 120. For example, each of the first insulating unit 132, the second insulating unit 133, and the third insulating unit 134 may include a digital isolator. For example, the third insulating unit 134 may be an insulating element which transmits a CAN communication signal between the high-voltage unit 110 and the low-voltage unit 12.

In addition, the control unit 114 may control each of the first insulating unit 132, the second insulating unit 133, and the third insulating unit 134 to be turned on or off. For example, when the control unit 114 detects a malfunction or failure of any one of the first insulating unit 132, the second insulating unit 133, and the third insulating unit 134, the control unit 114 may operate another of the first insulating unit 132, the second insulating unit 133, and the third insulating unit 134. In addition, when the control unit 114 determines that the first insulating unit 132, the second insulating unit 133, and the third insulating unit 134 have all malfunctioned or failed, the control unit 114 may turn off all of the first insulating unit 132, the second insulating unit 133, and the third insulating unit 134.

The second insulating unit 133 and the third insulating unit 134 may connect the communication unit 125 (or the voltage monitoring unit) and the control unit 114. The third insulating unit 134 may perform CAN communication. The third insulating unit 134 may transmit and receive signals CAN_TXD and CAN_RXD to and from the communication unit 125. In addition, the third insulating unit 134 may transmit and receive the signals CAN_TXD and CAN_RXD to and from the control unit 114.

The conversion unit 131 may be disposed between the low-voltage unit 120 and the high-voltage unit 110, may insulate a region from another region (the low-voltage unit from the high-voltage unit), and may convert only a voltage level.

The conversion unit 131 may boost the second power (second voltage) to the third power (third voltage). In addition, the conversion unit 131 may provide the third voltage to the high-voltage unit 110. In other words, the third voltage may be power of the high-voltage unit 110. For example, the conversion unit 131 may convert power of 5 V of the low-voltage unit into power of 15 V.

The conversion unit 131 may include a flyback converter. Accordingly, except for the elements (the first and the insulating units) for communication, only the conversion unit 131 is present as an element for power between the high-voltage unit 110 and the low-voltage unit 120.

The first insulating unit 132 may connect the elements (for example, including the second insulating unit) of the low-voltage unit and the control unit 114.

The second insulating unit 133 may connect the voltage monitoring unit 126 and the control unit 114. The third insulating unit 134 may connect the communication unit 125 and the control unit 114. In addition, as in FIG. 2, the first insulating unit to the third insulating unit may perform transmission and reception of signals between the low-voltage unit and the high-voltage unit.

As the elements disposed in the high-voltage unit 110 and the low-voltage unit 120 are applied as described above, additional insulating elements (for example, an integrated circuits (ICs)) are not needed. In other words, power efficiency can be improved. In addition, a large DC-DC converter for stepping a high voltage down may not be required. In other words, a miniaturized motor control device can be provided.

As described above, in the motor control device according to the embodiment 100, as the first power connection unit, the driving unit, and the control unit are the high-voltage unit which receives the first power, and the second power connection unit and the communication unit are the low-voltage unit which receives the second power, a separation distance for insulation and an arrangement of the insulating elements according to a difference in voltage between the battery 400 and the high-voltage battery 200 can be optimized. That is, in the present invention, as the elements are disposed in each of the high-voltage unit and the low-voltage unit, the efficient and compact motor control device can be provided using the conversion unit which converts a power level.

Further referring to FIG. 2, the first regulator 116 may be connected to the control unit 114. The first regulator 116 may provide a stepped-down voltage to the control unit 114. For example, the first regulator 116 may receive a portion of a voltage stepped up by the conversion unit 131. The first regulator 116 may step some of the stepped-up voltage down and provide the stepped-down voltage to the control unit.

In addition, the control unit 114 may be connected to the second regulator 124 through the insulating unit. For example, the control unit 114 may be connected to the second regulator 124 through the third insulating unit 134. The control unit 114 may provide an operation signal for driving to the second regulator 124. That is, in the low-voltage unit 120, the second regulator 124 may be connected to the control unit 114 and receive the operation signal of the control unit 114. In addition, the second regulator 124 may step the second power down and transmit a reset signal Reset to the control unit 114 in response to the operation signal of the control unit 114.

For example, the control unit 114 may provide a clock frequency to the second regulator 124. The second regulator 124 may include a watch dog and an output. The watch dog of the second regulator 124 may receive the operation signal (for example, the clock frequency, LCK) from the control unit 114 through the third insulating unit 134. The operation signal may include any frequency signal generated for monitoring the control unit 114. In addition, when the watch dog does not receive a clock signal due to an abnormal operation of the control unit 114, the watch dog may provide a reset signal to the control unit 114. In this case, the reset signal may be transmitted from the second regulator 124 to the control unit 114 through the third insulating unit 134. In addition, the second regulator 124 may receive “on” of the ignition key IGN or “IGN Enable” and may be driven. Through this configuration, since normal operation of the control unit 114 may be checked in the low-voltage unit, operation of the control unit may be checked normally even with an electrical issue of the high-voltage unit. In addition, the second regulator 124 may provide stepped-down voltages to other components of the low-voltage unit 120.

In addition, the third regulator 124′ of the low-voltage unit 120 may step the second power down and supply the stepped-down power to an external sensor. That is, the third regulator 124′ may include an output which outputs a stepped-down voltage. The output of the third regulator 124′ may supply power LDO_EXT to an external element, etc. In addition, the third regulator 124′ may receive a driving or on-signal LDO_5V or Enable from the output of the second regulator 124. Accordingly, a circuit of the low-voltage unit 120 can be electrically protected from a malfunction of or damage to an external sensor.

Further referring to FIGS. 3 and 4, in the low-voltage unit, the voltage monitoring unit 126 may include a first conversion circuit. Conversion circuits may be connected to a second power VBAT or VB and the ignition key IGN. For example, each of the conversion circuits may be connected to one of the second power VBAT or VB and the ignition key IGN.

In the embodiment, the conversion circuits may include a first conversion circuit 126a and a second conversion circuit 126b.

The first conversion circuit 126a may be connected to the second power VBAT. In addition, the second conversion circuit 126b may be connected to the ignition key IGN. Each of the conversion circuits may be connected to one of the second power VBAT or VB and the ignition key IGN though voltage distribution.

The conversion circuit may be connected to the control unit 114 of the high-voltage unit through the insulating unit (for example, the second insulating unit). In particular, the conversion circuit may convert an analog signal of the low-voltage unit to a digital signal and provide the converted digital signal to the control unit 114 through the second insulating unit.

The conversion circuit may include a triangular wave generation circuit and a comparator. The second conversion circuit 126b will be described below. However, description below may be equally applied to the first conversion circuit 126a. That is, the conversion circuit may include the triangular wave generation circuit and the comparator connected to the triangular wave generation circuit and any one of the second power and the ignition key.

In addition, the comparator may be connected to the control unit. For example, output power of the comparator may be provided to the control unit.

In addition, the conversion circuit according to the embodiment may output a signal with a duty ratio corresponding to a change in the second power or the ignition key. Accordingly, the control unit may receive a signal OUTPUT with the duty ratio corresponding to the conversion in the second power or the ignition key. In other words, the control unit may easily determine a voltage value of the second power VBAT or the ignition key IGN on the basis of duty ratio information of a digital signal. In this case, a period of a triangular wave may be shorter than a period of the second power or the ignition key. Accordingly, a signal with a more exact duty ratio may be provided to the control unit.

In addition, due to the conversion circuit, a circuit element (for example, an isolated operational amplifier (OP-AMP)) with a large volume may not be required. Accordingly, miniaturization can be achieved. In addition, as the second power or the ignition key is detected on the basis of a duty ratio, voltage generation in the low-voltage unit can be easily monitored The second conversion circuit 126b may include a triangular wave generation circuit 126bb and a comparator 126ba. The triangular wave generation circuit 126bb may be connected to any one of an inversion terminal and a non-inversion terminal of the comparator 126ba, and the ignition key IGN may be connected to the other of the inversion terminal and the non-inversion terminal.

For example, the ignition key IGN may be connected to the non-inversion terminal. The triangular wave generation circuit may be connected to the inversion terminal or a reference voltage terminal INPUT.

In addition, a period of the ignition key IGN may be longer than a period of a triangular wave input from the triangular wave generation circuit 126bb. When the ignition key IGN (red) is higher than 4.5 V, a region in which a magnitude of the triangular wave or a triangular waveform is smaller than that of the ignition key may be reduced. Accordingly, a duty ratio may be 90% or more.

Alternatively, when the ignition key IGN (red) is lower than 0.5 V, a region in which the triangular wave or triangular waveform is greater than the ignition key may be reduced. Accordingly, a duty ratio may be 10% or less.

As a modified example, the ignition key IGN may be connected to the inversion terminal or the reference voltage terminal INPUT. The triangular wave generation circuit may be connected to the non-inversion terminal. In addition, a period of the ignition key IGN may be longer than a period of a triangular wave input from the triangular wave generation circuit 126bb.

In addition, when the ignition key IGN (red) is higher than 4.5 V, a region in which a magnitude of the triangular wave or a triangular waveform is smaller than that of the ignition key may be reduced. Accordingly, a duty ratio may be 10% or less.

Alternatively, when the ignition key IGN (red) is lower than 4.5 V, a region in which a magnitude of the triangular wave or triangular waveform is greater than that of the ignition key may be reduced. Accordingly, a duty ratio may be 90% or more.

As described above, a magnitude or a change in magnitude of the ignition key or the second power may be easily detected through a value of a duty ratio or a change in duty ratio using a triangular wave and the comparator.

Further referring to FIG. 7, the vehicle control device according to the embodiment may further include a determination unit OR. The determination unit OR may be connected to the overcurrent detection circuit and the control unit. In addition, the overcurrent detection circuit 115 may be connected to the detection element (shunt) R disposed between the control unit and the motor.

In the embodiment, the determination unit OR may output an overcurrent detection signal upon detecting an overcurrent in any one phase from the overcurrent detection circuit 115 or the control unit 114. For example, when an overcurrent or short is detected, the overcurrent detection signal may be provided to the error detection unit 113c. In this case, the error detection unit 113c may stop operation of the driving unit.

The overcurrent detection circuit 115 and the control unit 114 may be connected to the detection element (shunt) R in parallel. For example, 3-phase voltage may be provided to each of the control unit and the overcurrent detection circuit from the detection element (shunt) R.

The overcurrent detection circuit 115 may include a plurality of comparators 115a, 115b, and 115c and a gate unit 115d.

Each of the plurality of comparators 115a, 115b, and 115c may be connected to one of 3-phase voltages of the detection element. For example, each of the 3-phase voltages may be input to one of the comparators from the detection element. The comparators may receive a reference voltage corresponding to an overcurrent or short.

The gate unit 115d may be connected to the plurality of comparators 115a, 115b, and 115c. The gate unit 115d may receive output signals from the plurality of comparators 115a, 115b, and 115c. Accordingly, when the gate unit 115d receives an output signal corresponding to an overcurrent from any one comparator of the plurality of comparators 115a, 115b, and 115c, the gate unit 115d may output an overcurrent detection signal to the determination unit OR.

In addition, when the determination unit OR receives any one of a failure detection signal (software (SW) failure detection signal) of the control unit or an overcurrent detection signal (hardware (HW) overcurrent detection signal) of the gate unit, the determination unit OR may output a failure signal (for example, an overcurrent detection signal) to the error detection unit 113c. Operation of the driving unit may be stopped in response thereto. Due to such a structure, damage to the driving unit 113 for a time (for example, several milli seconds) after an over current occurs due to a delayed calculation time and delayed signal transmission of the control unit can be prevented. In other words, the operation of the driving unit can be exactly and quickly stopped by the control unit and the overcurrent detection circuit checking any one phase of 3 phases connected to the motor. Accordingly, the reliability of the motor control device can be further improved.

In addition, while the present disclosure has been described with reference to embodiments above, the embodiments are only exemplary and do not limit the present specification, and it will be understood by those skilled in the art that various changes and applications which are not illustrated above may be made without departing from the essential characteristics of the present embodiments. For example, the components specifically described according to the embodiments may be modified. In addition, such differences relating to the modifications and applications should be understood to be included in the scope of the present specification defined by the appended claims.

1. A motor control device comprising:
a first power connection unit which receives first power;
a second power connection unit which receives second power lower than the first power;
a driving unit which is connected to a motor and drives the motor by supplying the first power to the motor;
a control unit which transmits a pulse width modulation signal for driving the motor to the driving unit, and
an insulating unit and a conversion unit which are disposed between and connected to a high-voltage unit and a low-voltage unit,
wherein the high-voltage unit includes the first power connection unit, the driving unit, and the control unit and receives the first power,
the low-voltage unit includes the second power connection unit and receives the second power, and
the low-voltage unit resets the control unit according to whether the control unit operates.

2. The motor control device of claim 1, wherein the conversion unit insulates the high-voltage unit from the low-voltage unit and provides third power stepped up from the second power to the high-voltage unit.

3. The motor control device of claim 2, wherein the third power is provided to the driving unit.

4. The motor control device of claim 3, wherein the high-voltage unit includes:
a first regulator which is connected to the conversion unit and steps the third power down; and
a sensor power unit.

5. The motor control device of claim 4, wherein the first regulator provides the stepped-down power to the control unit.

6. The motor control device of claim 5, wherein the low-voltage unit includes:
a second regulator which is connected to the control unit and receives an operation signal of the control unit; and
a third regulator which provides power to an external sensor.

7. The motor control device of claim 6, wherein the second regulator steps the second power down and transmits a reset signal to the control unit in response to the operation signal of the control unit.

8. The motor control device of claim 2, wherein:
the low-voltage unit includes a conversion circuit connected to each of the second power and the ignition key.

9-10. (canceled)

11. The motor control device of claim 8, wherein the conversion circuit includes a triangular wave generation circuit and a comparator connected to the triangular wave generation circuit and any one of the second power and the ignition key.

12. The motor control device of claim 11, wherein the comparator is connected to the control unit.

13. The motor control device of claim 11, wherein the conversion circuit outputs a signal with a duty ratio corresponding to a change in the second power or the ignition key.

14. The motor control device of claim 11, further comprising an overcurrent detection circuit connected to a detection element disposed between the motor and the control unit.

15. The motor control device of claim 14, further comprising a determination unit connected to the overcurrent detection circuit and the control unit.

16. The motor control device of claim 15,
wherein the determination unit output an overcurrent detection signal upon detecting an overcurrent in any one phase from the overcurrent detection circuit or the control unit.

17. The motor control device of claim 15,
wherein the detection element may be connected to the control unit.

18. The motor control device of claim 15,
wherein the determination unit transmits an overcurrent detection signal to the error detection unit when an overcurrent or short circuit is detected.

19. The motor control device of claim 15,
wherein the overcurrent detection circuit and the control unit are connected in parallel to the detection element.

20. The motor control device of claim 15,
wherein 3-phase voltage is provided from the detection element to each of the control unit and the overcurrent detection circuit.

21. The motor control device of claim 20,
wherein the overcurrent detection circuit includes a plurality of comparators and a gate unit.

22. The motor control device of claim 15,
wherein the plurality of comparators are each connected to one of the 3-phase voltages and receive a reference voltage corresponding to an overcurrent or short circuit.
